(19) United States
(12) Patent Application Publication
(10) Pub. No.: US 2012/0198387 A1
(43) Pub. Date: Aug. 2, 2012

(54) Floral Arrangement Tool and Method

(76) Inventor: Bonnie Gail Henry, Amesbury, MA (US)

(21) Appl. No.: 13/196,079

(22) Filed: Aug. 2, 2011

Related U.S. Application Data
(60) Provisional application No. 61/372,769, filed on Aug. 11, 2010.

(51) Int. Cl. G06F 3/048

(52) U.S. Cl. 715/845

(57) ABSTRACT

A computer-implemented method and tool for creating a virtual floral arrangement includes at least one electronic floral template, a flower type set associated with the floral template, the flower type set including one or more flower types, and a parameter set associated with at least one of the floral template and flower types, the parameter set including at least one randomizable parameter. A graphical user interface is configured to display the floral template and flower type set to the user, while also permitting the user to select from among the flower types for display. A flower randomizer is configured to randomize the randomizable parameter, to generate variations in appearance of the displayed flower type, so that a draft arrangement is created and displayed, which includes the template, the selected flower type and the randomized parameter.

### RELATED APPLICATION

This application claims the benefit of U.S. Provisional Patent Application Ser. No. 61/372,769, entitled Floral Arrangement Tool and Method, filed on Aug. 11, 2010, the contents of which are incorporated herein by reference in their entirety for all purposes.

### BACKGROUND

1. Technical Field

This invention relates to virtual object imaging and modeling, and more particularly to creation and editing of realistic looking virtual floral arrangements using randomization algorithms.

2. Background Information

When ordering a floral arrangement, or a set of floral arrangements, from a florist, a customer often has incomplete information as to what the arrangements would look like. A florist may not have the desired flowers on hand to create a demonstration arrangement. In addition, a customer ordering a set of identical arrangements may not realize that each arrangement in the set is likely to look somewhat different. This is because in nature, no two flowers look exactly alike. Also, a florist creating the arrangements is likely to “eyeball” the placement of each flower of the arrangement, so that the placement of the flowers would different slightly from arrangement to arrangement.

In order to create sample floral arrangements without actually having to order the flowers for them, one may attempt to create a virtual floral arrangement using software with a computer (“currently available tools”). However, it is believed that currently available tools have certain drawbacks. For example, currently available tools display only modular, idealized, abstractions of flowers, which do not provide realistic depictions of finished bouquets. Currently available tools also do not display variations in placement of individual flowers in multiple floral arrangements.

Thus, a need exists for a floral arrangement tool which provides the user with a more realistic portrayal of what a proposed floral arrangement would actually look like.

### SUMMARY

In one aspect of the present invention, a computer-implemented tool for creating a virtual floral arrangement includes a floral template module including at least one electronic floral template, a flower type module including at least one flower type set associated with the floral template, the flower type set including one or more flower types, and a parameter module including a parameter set associated with at least one of the floral template and flower types, the parameter set including at least one randomizable parameter. A graphical user interface module is configured to generate a graphical user interface to display the floral template and flower type set to the user, while also permitting the user to select from among the flower types for display. A flower randomizer is configured to randomize the randomizable parameter, to generate variations in appearance of the displayed flower type, so that a draft arrangement is created and displayed, which includes the template, the selected flower type and the randomized parameter.

In another aspect of the invention, a computer-implemented method for creating a virtual floral arrangement includes providing at least one electronic floral template, associating at least one flower type set, including one or more flower types, with the floral template, and associating a parameter set with at least one of the floral template and flower types, the parameter set including at least one randomizable parameter. The method also includes enabling a graphical user interface to display the at least one floral template to a user, permitting the user to select from among the flower types for display, and randomizing the randomizable parameter, to generate variations in appearance of the displayed flower type, so that a draft arrangement including the template, the selected flower type, and the randomized parameter, is created and displayable on the user interface.

In yet another aspect of the invention, an article of manufacture for creating a virtual floral arrangement includes a computer usable medium having a computer readable instructions embodied therein, including instructions for implementing the computer-implemented method of the method described in the immediately preceding paragraph.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of one embodiment of a computer-implemented floral arrangement tool;

FIG. 2 is a block diagram of another embodiment of a computer-implemented floral arrangement tool;

FIG. 3 is a block diagram of graphical user interface aspects usable with the embodiment of FIG. 1;

FIG. 4 is a block diagram of graphical user interface aspects usable with the embodiment of FIG. 2;

FIG. 5 is a block diagram of exemplary templates of the embodiments of FIGS. 1 and 2;

FIG. 6 is a block diagram of exemplary templates of the embodiments of FIGS. 1 and 2;

FIG. 7 is a block diagram of exemplary flower types of the embodiments of FIGS. 1 and 2;

FIG. 8 is a block diagram of exemplary parameters of the embodiments of FIGS. 1 and 2;

FIG. 9 is a block diagram of one embodiment of a network-based transaction facility of the present invention;

FIG. 10 is a simplified block diagram of one embodiment of a system of the present invention including a transaction facility; and

FIG. 11 is a block diagram of an exemplary embodiment of a computer system usable in connection with the foregoing embodiments.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

In the following description, for purposes of explanation, numerous specific details are set forth in order to provide a thorough understanding of the present invention. It will be evident, however, to one skilled in the art that the present invention may be practiced without these specific details.

Briefly, embodiments of the invention include a computer-implemented tool for creating and editing realistic looking virtual floral arrangements. One or more randomizable parameters, such as petal color, petal size, petal shape, flower color, flower size, and flower shape, are configured to be varied using a flower randomizer. The placements of individual flowers, within an arrangement, are optionally configured to be randomized using a placement randomizer. In some embodiments, the randomizers are implemented using randomization algorithms.

Embodiments of the computer-implemented tool for creating a virtual floral arrangement include:
a set of electronic floral arrangement templates, each template including a set of flower types;
the flower type including a set of parameters, such as flower color and flower shape, wherein at least one parameter is randomizable;
a user interface configured to display:
   the set of templates to a user, so that the user may choose a template;
   the set of flower types for the chosen template, so that the user may choose one or more flower types;
   one or more parameter for the flower type, so that the user may choose a parameter;
a flower randomizer configured to randomize at least one flower type parameter, thereby creating variations on the appearance of the flower;
the user interface also configured to display the draft arrangement, the draft arrangement comprising the chosen template with the chosen flower types and chosen parameters, with the variations on the appearance of the chosen flower type.
   The flower randomizer includes variations in the individual flowers, such as their sizes, shapes, color shades, and petal type. This also serves to create more realistic looking representations of flower arrangements, because no two flowers look exactly alike. Some embodiments include a placement randomizer configured to place flowers randomly throughout the arrangement, for display on the user interface. This is useful for creating more realistic looking representations of flower arrangements, because florists tend to arrange flowers somewhat randomly in actual arrangements.

In some embodiments, the flower randomizer includes randomization algorithms. For example, some embodiments employ a Monte Carlo algorithm to introduce randomness into the appearance of individual flowers in a floral arrangement.

Some embodiments allow a user to edit an existing floral arrangement template. Such embodiments of the computer-implemented tool for creating a virtual floral arrangement may include:
an electronic floral arrangement original template, the original template including one or more flower types;
the flower type including a set of parameters, wherein at least one parameter is randomizable, wherein the original template's flower type is pre-selected;
a user interface configured to display the original template to a user;
a flower randomizer configured to randomize at least one flower type parameter for display, thereby creating variations on the appearance of the flower;
wherein the user interface is configured to allow a user to edit a flower type of the original template to create an edited template, the editing including removing a flower type and adding a flower type;
wherein the user interface is configured to allow a user to edit a parameter for the flower type;
wherein the user interface is configured to display the edited template.
   Some embodiments of this editing tool include a placement randomizer as described above.

Terminology

For the purposes of the present specification, the term “transaction” shall be taken to include any communications between two or more entities and shall be construed to include, but not be limited to, commercial transactions including sale and purchase transactions, e.g., for the generation of floral arrangements, the actual generation of floral arrangements using the embodiment hereof, and the like.

As used herein, the terms “computer” and “end-user device” are meant to encompass a workstation, personal computer, personal digital assistant (PDA), wireless telephone, or any other suitable computing device including a processor, a computer readable medium upon which computer readable program code (including instructions and/or data) may be disposed, and a user interface. Terms such as “server”, “application”, “engine” and the like are intended to refer to a computer-related component, including hardware, software, and/or software in execution. For example, an engine may be, but is not limited to being, a process running on a processor, a processor including an object, an executable, a thread of execution, a program, and a computer. Moreover, the various components may be localized on one computer and/or distributed between two or more computers. The terms “real-time” and “on-demand” refer to sensing and responding to events nearly simultaneously (e.g., within seconds or milliseconds) with their occurrence, or without intentional delay, given the processing limitations of the system and the time required to accurately respond to the inputs. The term “flower type” refers to substantially anything that may be put in a floral arrangement, including flowers, berries, leaves, twigs, lights, and non-plant ornaments (e.g., plastic or glass ornaments).

Programming Languages

The system and method embodying the present invention can be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

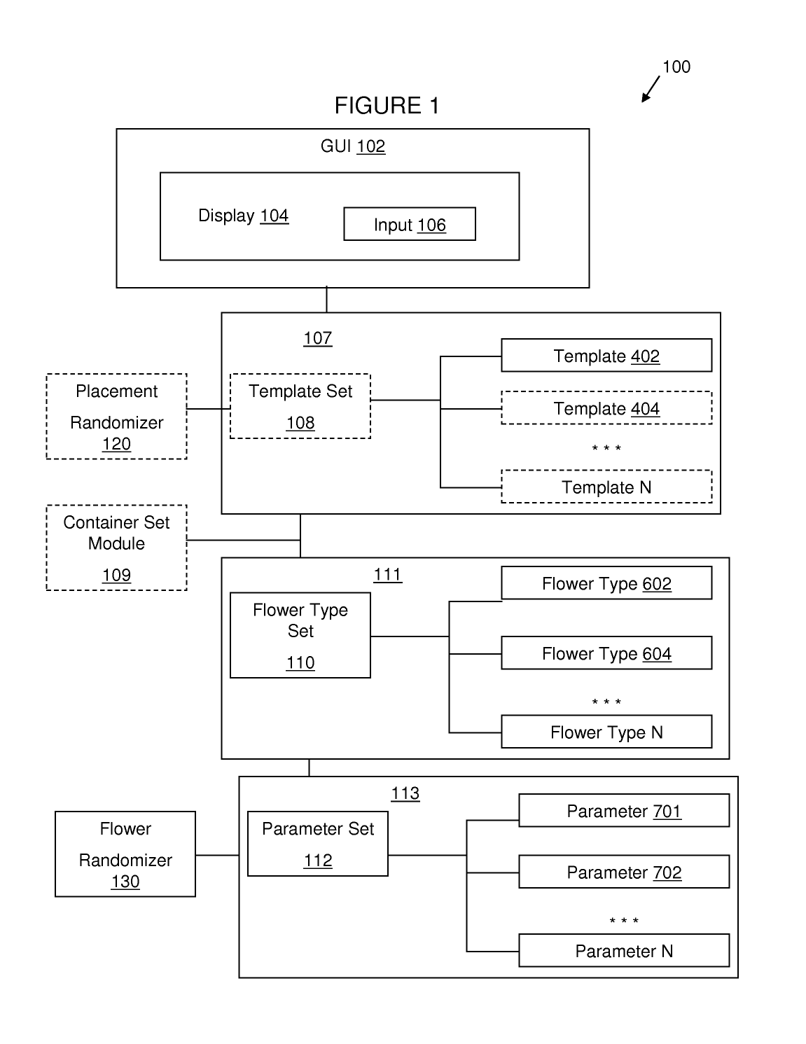

Referring now to FIGS. 1-11, embodiments of the present invention will be more thoroughly described.

In the embodiment of FIG. 1, system 100 includes a graphical user interface (GUI) module 102 configured to generate a display 104 and user input 106. Display 104 may be presented to a user in substantially any manner known to those skilled in the art, such as via CRT, flat screen, touch screen, etc. Similarly, user input 106, which may include selectable buttons, links, menus, etc., presented on display 104, may be actuated in substantially any manner known to those skilled in the art, including a mouse, digital pen, track ball, track pad, touch screen, voice activation, keyboard, etc. The GUI is configured to allow the user to build a floral arrangement, such as a centerpiece, a bridal bouquet, or a funeral wreath, etc., such as will be described in greater detail hereinbelow.

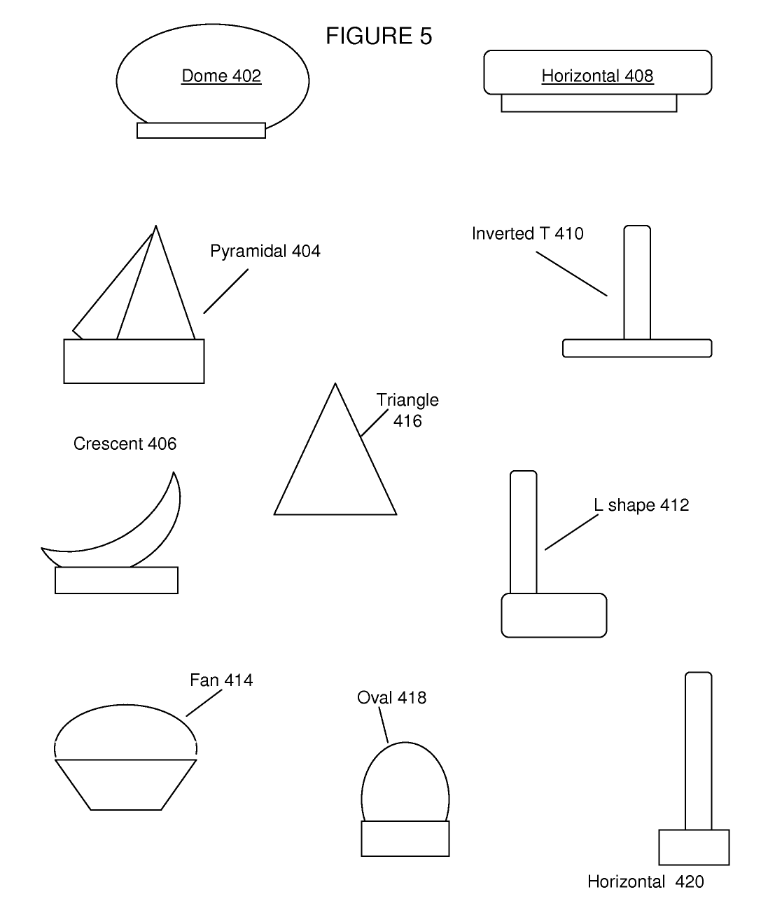

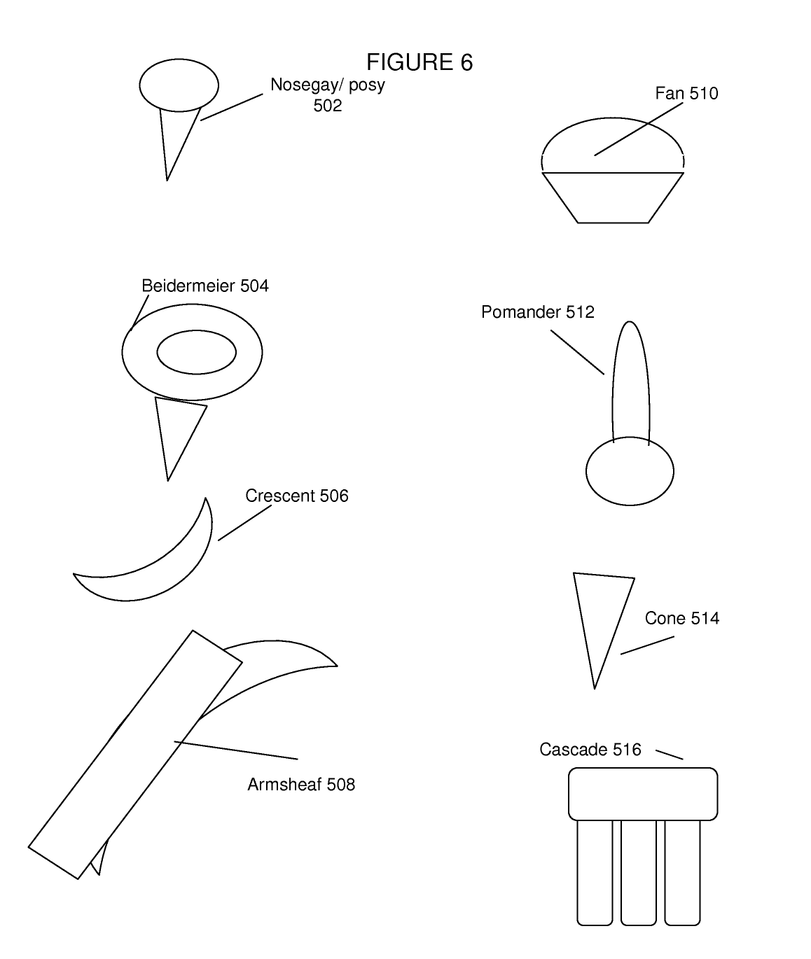

System 100 also includes a template module 107 configured to display at least one electronic floral template 402, such as may be optionally presented as a component of a template set 108, e.g., having multiple templates 402, 404, etc. Representative examples of centerpiece-type layout templates includable in the set 108 are shown in FIG. 5. Similarly, representative examples of bouquet-type templates includable in set 108 are shown in FIG. 6. The set of layout templates 108 is not limited to the examples of FIGS. 5 and 6, and may include substantially any floral arrangement layout type, such as corsages, wristlets, hairpieces, wall garlands and arrangements for church pews, etc. In some embodiments, the set of layout templates 108 is predetermined, and is not configured for the addition or removal of individual templates by the user. In other embodiments, the set of layout templates 108 is configured to include additional templates added by the user, and to remove templates deleted by the user.

In some embodiments, the user may begin by first choosing a container for the template. For example, an optional container set module shown in phantom at 109, may be configured to display a selection of containers, such as vases, boxes, and baskets; or bases for hairpieces, such as combs, bobby pins, and barrettes, etc., (not shown). A flower type module 111 is configured to enable the user to choose one or more flower types 602, 604, etc., e.g., from a flower type set 110, as will be discussed in greater detail hereinbelow. Although templates 402, 404, etc., may be preconfigured for a predetermined number of flowers, in some embodiments, GUI 102 may be configured to allow a user to edit the number of flowers, e.g., within predetermined ranges, depending on the particular chosen template.

Returning to FIG. 1, as mentioned, GUI 102 may be configured to allow the user to choose a template from a set of templates 108. For ease of explication, this and subsequent aspects of embodiments of the invention will be described with reference to a representative example (referred to hereinbelow as Example 1), in which the user initially chooses a template in a dome shape as shown at 402 of FIG. 5.

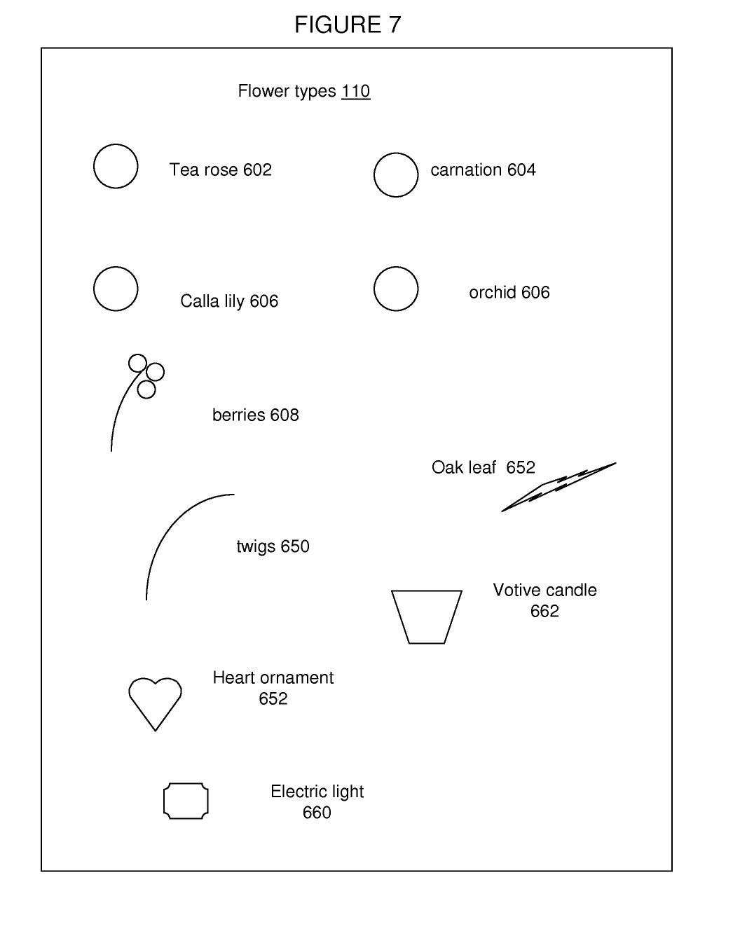

In addition to optionally enabling the user to select a container from container set 109, as mentioned above, the system is also configured to allow a user to choose one or more flower types 602, 604, etc., from the set of flower types 110. It should be recognized that the set of flower types 110 is not limited to flowers, as discussed hereinbelow. As shown in FIG. 7, examples of flower types may include flowers such as tea rose 602, carnation 604, calla lily 606, and orchid 606. In addition to flowers, other plant based types may be offered, for example berries 608, twigs 650, and oak leaf 652. Still further, set 110 may include aspects which are not plant based. For example, various ornaments, such as heart ornament 652 may be included, as well as lighting aspects such as electric light 660 and votive candle 662. The examples of FIG. 7 are not exclusive. Instead, substantially anything that may be included as part of an arrangement may be included in the flower type set 110, such as ribbon, lace, rocks, shells, beach glass, pinecones, pillows, colored pins, floral tape, and magnets, etc. In Example 1, the user selects a tea rose 602.

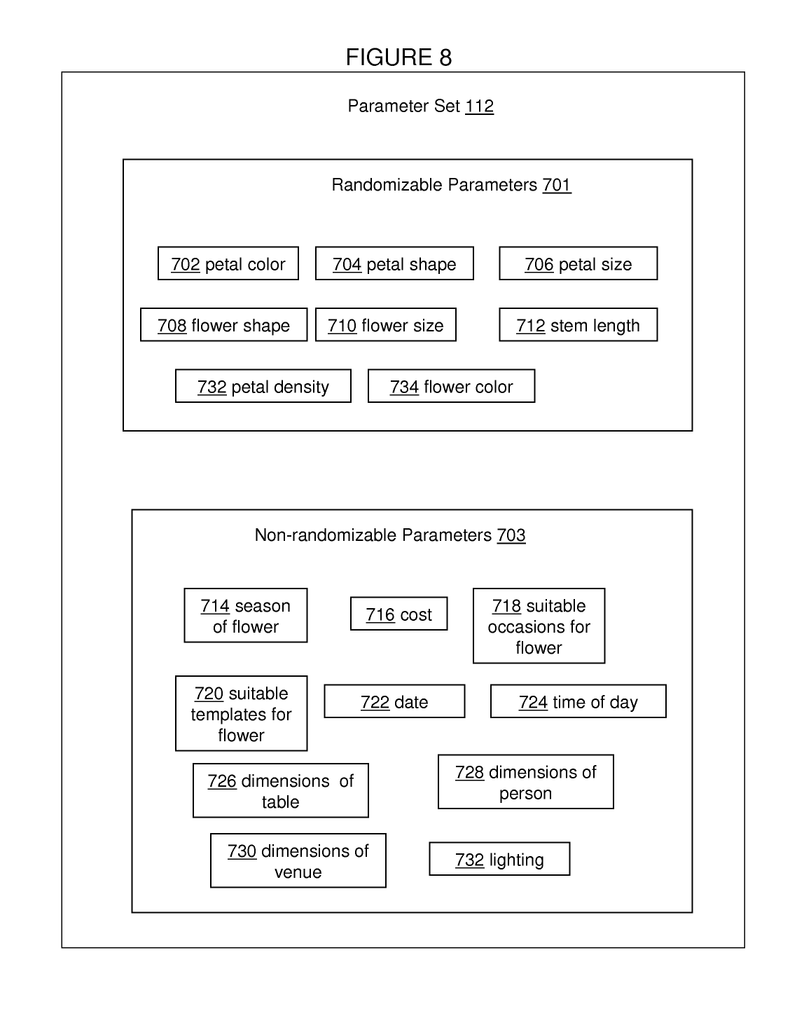

System 100 may also include a parameter module 113 configured to allow a user to choose parameters 701, 702, etc., e.g., from a parameter set 112, to be applied to the flower types/templates/containers selected as described above. An exemplary parameter set 112 is shown in FIG. 8, which includes randomizable parameters 701, which may include petal color 702, petal shape 704, petal size 706, flower shape 708, flower size 710, stem length 712, petal density 732, and flower color 734.

Parameter set 112 may also include non-randomizable parameters 703, such as seasons 714 for which a flower is normally available, cost 716 of the flower type, occasions 718 for which a flower type is suitable (e.g., wedding vs. funeral), templates 720 (arrangement shapes) for which a flower type is suitable; and date 722 when the floral arrangement would be used. Additional non-randomizable parameters may relate to the context in which the floral arrangement would be used, such as container type/size, time of day 724, dimensions of table 726 (e.g., for centerpiece), dimensions of person 728 (e.g. for bridal bouquet or groom boutonniere), dimensions of venue 730 (e.g., reception hall), and lighting 732 (e.g., candlelight or daylight).

The examples of parameters listed in FIG. 8 are not exclusive. Instead, substantially any parameter may be included in the set 701 of randomizable parameters, and in the set 703 of non-randomizable parameters.

Continuing with Example 1, the user may then decide certain parameters for the tea rose 602, such as petal color 702 in red (FIG. 8). The user may choose additional flower types with additional parameters, but Example 1 will include only tea rose 602, and a red color 702 of red, for simplicity of explanation.

Returning to FIG. 1, flower randomizer 130 is configured to introduce a more realistic look to the display of the chosen template. In Example 1, flower randomizer 130 creates a more realistic look for dome template 402, with tea rose 602, and red color parameter 702. For example, different shades of red may be randomly assigned to different parts of the rose, and different parts of the petal of the rose. In addition, individual petal sizes and shapes may also be randomized. Optionally, the number and density of petals may also be varied from flower to flower. Practitioners in the art will recognize that any number of conventional randomization algorithms may be employed in the randomizer 130. The flower randomizer 130 is therefore configured to provide a more realistic view of what the actual floral arrangement of Example 1 would look like.

Also, it will be recognized that actual floral arrangements have a somewhat random placement of flowers. This is due to the fact that arrangements are not created by mechanical processes, with exact placement of each element. Instead, floral arrangements are generally assembled by humans who estimate, or “eyeball,” where each flower should go. Therefore, to make a realistic virtual floral arrangement, some randomness in the placement of the individual flowers is beneficial. It is not necessary to have a completely random placement throughout the entire arrangement, but some predetermined amount of leeway, for example, of two inches in any direction, may be appropriate.

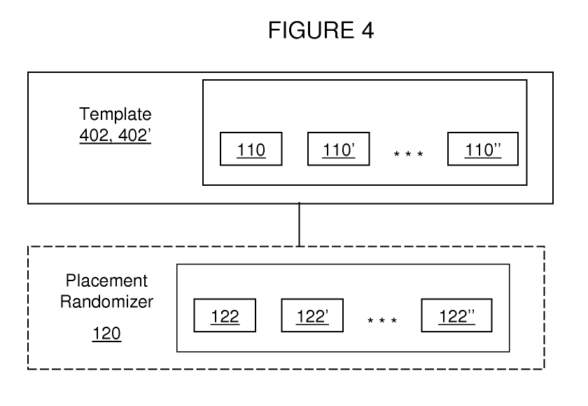

To provide still further realism to the virtual flower arrangement, particular embodiments may included an optional placement randomizer 120 configured to introduce some randomness into the placement of each individual flower. For example, as shown in FIG. 4, optional placement randomizer 120 may be used to randomize the locations 122 (e.g., 122′, 122″, 122″′, etc) of various features (e.g., flowers) within the template chosen from template set 108. In particular embodiments, placement randomizer adjusts some locations 122 by adjusting the location within the aforementioned predetermined amount of leeway, e.g., of up to about two inches (approximately 5 cm), in a life-size rendering. It should be understood that this leeway may be scaled in accordance with the scale of the display, so that a rendering which displays the flowers at 50% of life size, would also indicate a 50% reduction in the leeway from 5 cm to 2.5 cm.

Returning to FIG. 1, the display 104 is thus configured to present to the user, the result of the various selections, including the chosen template with the chosen flower types and chosen parameters, and with the variations on the appearance, and optionally position, of the chosen flower type. This presentation may be referred to herein as a draft arrangement, and in particular embodiments, is updated in real time in response to the user's selections. Referring back to Example 1, the draft arrangement displayed by GUI 102 includes the dome shape template 402 with randomization in the red petal color, and overall flower size, and also randomization in locations of individual flowers within the template 402.

The present inventor also recognized that florist customers often order multiples of the same floral arrangement. Although the arrangements are all of the same type, each actual arrangement will look slightly different, e.g., due to natural variations of the actual flowers, and placement of each flower by the florist, as discussed above. Likewise, each time a draft arrangement is rendered (and randomized in accordance with embodiments of the present invention), it may look somewhat different from the previous time it was rendered/randomized. Display 104 may therefore be optionally configured to display multiple versions of the draft arrangement, e.g., side-by-side or sequentially, to advantageously show realistic looking multiple arrangements.

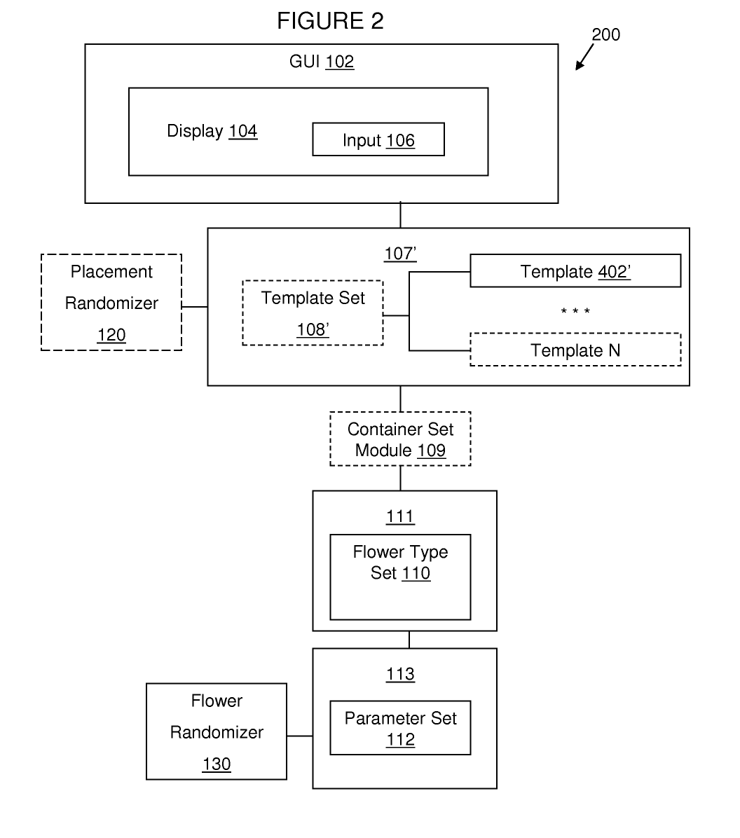

In addition, or instead of, creating a floral arrangement from scratch, a user may want to edit an existing floral arrangement, e.g., a previously configured draft arrangement. Some users may desire more guidance in the choosing of the floral arrangements, for example, by starting from samples of floral arrangements. The user may then make changes to a sample/draft arrangement in order to customize it to the user's tastes and needs. An embodiment configured to provide this feature is shown as system 200 in FIG. 2.

Turning now to FIG. 2, system 200 is substantially similar to system 100, with the following distinctions. In this embodiment, template module 107′ is configured to present a pre-configured draft arrangement in the form of one or more initial templates 402′, etc., which are similar to template set 402, while being pre-populated with the one or more flower types 602, 604, etc., optionally one or more containers from container set module 109, and one or more parameters from parameter set 112. Flower type module 111 and parameter module 113, and optional container set module 109 may be used substantially as described hereinabove to permit the user to edit the template 402′, such as by adding or removing a container, adding or removing flower types, and selecting or deselecting a parameter from the parameter set. The edited template may be displayed in real-time via display 104.

The particular flower type sets 110 available to the user may be predetermined, e.g., based on the particular initial draft arrangement 402′ selected by the user, and may or may not be configured for being changed or overridden by the user. In other embodiments, the flower type set 110 may be configured to allow a user to add her own flower types, and optionally to remove flower types from the set.

Flower randomizer 130 and optional placement randomizer 120 are configured to randomize, as discussed above, the display of initial draft arrangement 402′, etc. In some embodiments, this initial draft arrangement 402′ may be a draft arrangement previously configured by the user, such as described above with respect to Example 1. Regardless of whether the initial draft arrangement 402′ originated with a user and was saved by the system for re-use, or was originally provided by the system 100, 200, this arrangement 402′ may be considered a starting point for the user in a guided process.

One or more draft arrangements 402′ may be incorporated into one or more template sets 108′, for selection by the user. For example, the templates 402′, 404′, etc., as well as one or more templates 402, 404, 502, 504, etc., of FIGS. 5 and 6, respectively, may be displayed for selection by the user. In some embodiments, the initial draft arrangements may be placed in sets 108′ with templates grouped by categories, such as centerpieces, bridal bouquets, garlands, and funeral wreaths. The sets 108′ of some embodiments may be predetermined, and not configured to be changed by the user, while in other embodiments, the user may add or delete draft arrangements 402′ to and from the sets 108′.

It should be noted that although initial draft arrangements 402′ may be associated with particular pre-populated aspects as discussed hereinabove, other draft arrangements may not be pre-populated or otherwise associated with some aspects. For example, some draft arrangements may not include any suggested flower types 602, but may instead be presented with “blank” flower types. GUI 102 may thus be configured to allow a user to choose among flower types 502, 504, etc., with or without any guidance provided by pre-populated/suggested flower types.

As discussed above, various embodiments permit the user to edit the parameters and/or containers, flower types, etc., associated with the chosen initial draft arrangement 402′. However, in some embodiments, the particular flower type set(s) 110 and/or parameter set(s) 112 associated with the particular draft arrangement 402′ selected by the user, may or may not be editable by the user. In various embodiments, the parameter set(s) 112 may or may not be configured to allow a user to add the user's own parameters, and optionally to remove parameters from the set. As discussed above, in particular embodiments, parameter set(s) 112 include at least one randomizable parameter which may be randomized by flower randomizer 130 and/or optional placement randomizer 120. Flower randomizer 130 is configured to randomize at least one parameter of the edited draft arrangement, and display 104 is configured to display the edited draft arrangement.

In another representative example, (Example 2) the embodiment of FIG. 2 may be used, in which the user begins by selecting an initial draft arrangement set 402′ which may include a dome template 402 with red tea roses 602, such as used in Example 1. In this example, the user may choose to add white orchids to this initial draft arrangement 402′. Therefore, in addition to initial flower type 602 (tea roses), the user may select orchid flower type 606, and choose flower color 734 in white. In this example, flower randomizer 130 is configured to randomize the orchids so that various shades of white are applied thereto, and optional placement randomizer 120 is configured to randomize the locations of the orchids among the red tea roses. (Randomizer may also randomize the locations of the red tea roses.) Display 104 is configured to display the edited template with the randomized flowers.

In some embodiments, the user may be provided with additional guidance in building a floral arrangement. For example, not all flower types are appropriate for all templates. A fan template 510 (FIG. 6) generally requires flowers with strong stems. Therefore, in some embodiments, flower types with weak stems will be associated with a pre-set parameter 720, e.g., to indicate that these flower types are not recommended for fan arrangements.

In some embodiments, the tool is configured to allow the user to customize certain contextual parameters. For example, a bride may upload photos of herself to be included in the display 104 of a floral arrangement. A bride may also upload her size for the dimensions of a person 728 parameter (FIG. 8). In addition, some embodiments are configured to allow a user to adjust the size of a template to coordinate with the person's size. A user may include a picture of the bride's face and figure, as well as a picture of the bride's dress, and optionally pictures of bridesmaids dresses and planned clothing for additional members of the wedding party. Alternatively, a user may enter parameters relating to clothing, such as color and style, rather than uploading photos.

The tool of some embodiments is configured to allow a user to upload photos of additional contextual parameters, such as the venue. For example, a bride may upload photos of a reception hall for display with the floral arrangement template. In some embodiments, the tool is configured for additional customizations by the user, such as well as the time of day and the season of a planned event for which the floral arrangements will be used. Embodiments allow a user to upload expected types of lighting for the event, for example, sunny outdoor light, cloudy outdoor light, indoor lighting, and candlelight. Embodiments may also include additional contextual parameters for centerpieces, relating for example to colors and styles of tablecloths, napkins, china, candles, and additional decorations.

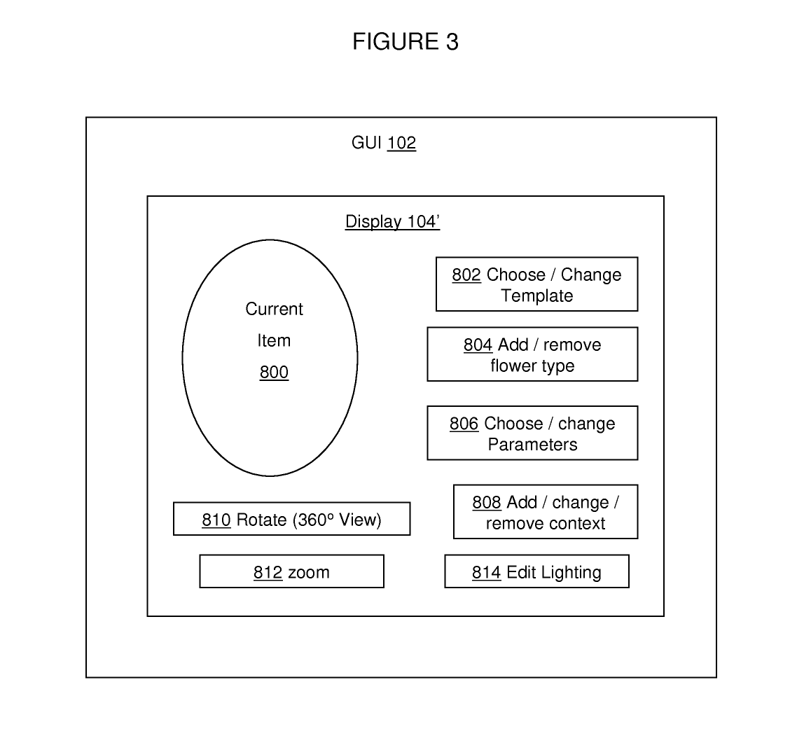

Turning to the embodiment of FIG. 3, display 104′ of GUI 102 may include the item 800 that the user is currently viewing. In this embodiment, the display 104 is configured to facilitate user input though clickable buttons, such as rotating a view 810, and zooming a view 812. In addition, display 104 of this embodiment is configured to allow a user to build or edit an arrangement, through such as choosing/changing a template 802, adding/editing a flower type 804, choosing/changing parameters 806, adding/changing contextual parameters 808, and adding/editing lighting 814.

Turning to FIG. 4, in any of the embodiments discussed herein, each particular template 402, 404, etc., and/or draft arrangement template 402′, etc., may include or otherwise be associated with one or more particular flower type sets 110, 110″, etc, that may be suitable for use therewith, as discussed hereinabove. In addition, optional placement randomizer 120 may include a set of varied locations 122, 122′, etc., for each flower type in the arrangement.

Some embodiments include a network based tool, and some embodiments, discussed below, include user accounts and email communications, for example, with a GUI configured to allow the user to email a picture of a display of a chosen template, with optional contextual parameters.

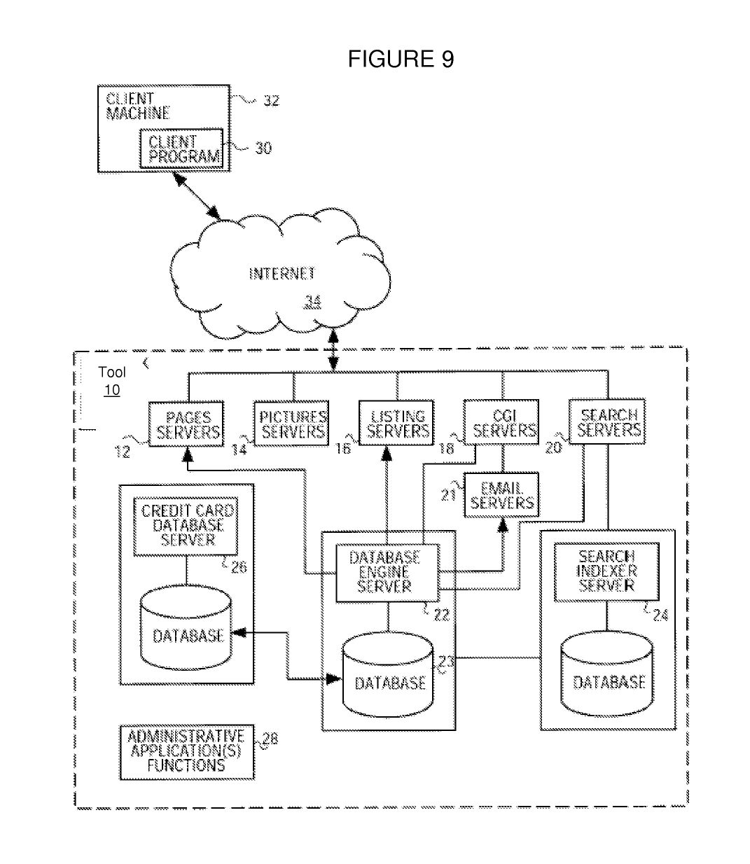

Embodiments of the tool may be used in virtually any device with a processor, for example, as part of a mobile phone application. Embodiments of the tool may be accessed by internet. FIG. 9 is a block diagram illustrating an exemplary network-based tool in the form of an Internet-based tool 10. The tool 10 includes one or more of a number of types of front-end servers, namely page servers 12 that deliver web pages (e.g., markup language reports), picture servers 14 that dynamically deliver images to be displayed within Web pages, listing servers 16 that maintain mailing lists; CGI (Common Gateway Interface) servers 18 that provide an intelligent interface to the back-end of facility 10, and search servers 20 that handle requests to the tool 10. E-mail servers 21 provide e-mail, Instant Message, text message, and/or other electronic communications capability to users of the facility 10. The back-end servers may include a database engine server 22, a search indexer server 24 and/or a payment (e.g., credit card and/or subscription) database server 26, each of which may maintain and facilitate access to a respective database. Tool 10 may also include an administrative application server 28 configured to provide various administrative functions.

The network-based tool 10 may be accessed by a client program 30, such as a browser (e.g., the Internet Explorer distributed by Microsoft) that executes on a client machine 32 and accesses the tool 10 via a network such as, for example, the Internet 34. Other examples of networks that a client may utilize to access the tool 10 include a wide area network (WAN), a local area network (LAN), a wireless network (e.g., a cellular network), or the Plain Old Telephone Service (POTS) network.

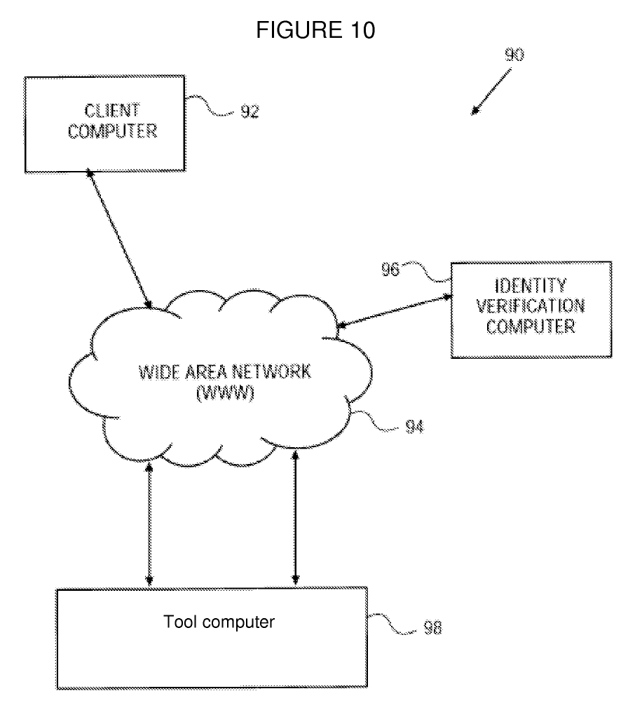

FIG. 10 is a simplified block diagram of a system 90 for creating and editing floral arrangements in accordance with an exemplary embodiment of the present invention. In this embodiment, a client computer 92 is coupled to a tool computer 98 via a communications network (e.g. a wide area network) 94. The client computer 92 represents a device that allows a user to interact with the tool 10 or any other tool 98. In one embodiment, the client computer 92 presents to the user a GUI for building virtual floral arrangements associated with the tool computer 98.

The tool (e.g., transaction) computer 98, which supports a tool facility such as shown at 10 of FIG. 9, handles transactions between various participants of the tool 10 including the user of the client computer 92. In one embodiment, the tool computer 98 may initially receive the personal information of the participant from the client computer 92, and generate a subscription result which determines whether, and to what extent, the user is granted access to the tool 10. The transaction computer then facilitates the generation of custom virtual floral arrangements in accordance with the GUI presented by the computer 98, via the client computer 92, to the user.

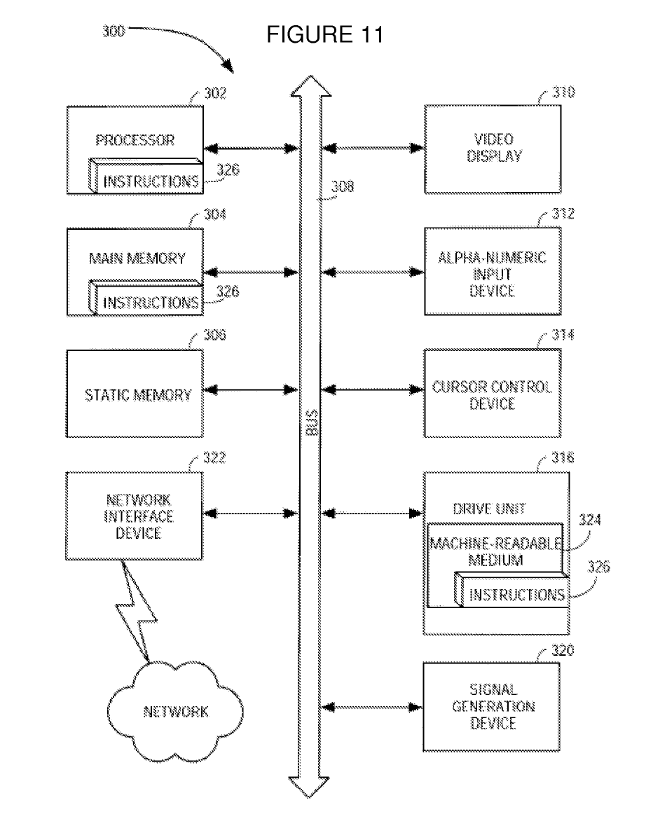

FIG. 11 shows a diagrammatic representation of a machine in the exemplary form of a computer system 300 within which a set of instructions, for causing the machine to perform any one of the methodologies discussed above, may be executed from either the standpoint of the server (tool computer) 98 or client computer 92. In alternative embodiments, the machine may include a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard or touchscreen), a cursor control device 314 (e.g., a mouse), a drive (e.g., disk, flash memory, etc.) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories, optical and magnetic disks, etc.

The above illustrative examples demonstrate certain aspects and embodiments of the present invention, and are not intended to limit the present invention to any one particular embodiment or set of features.

Thus, a tool for creating and editing floral arrangements has been described. Although the present invention has been described with reference to specific exemplary embodiments, it will be evident that various modifications and changes may be made to these embodiments without departing from the broader spirit and scope of the invention. For example, although particular embodiments have been shown and described as implemented in a network-based transaction facility, it should be recognized that the embodiments may be implemented in a stand-alone, e.g., non-network-based environment without departing from the scope of the present invention. In addition, although examples of particular items useful in floral arrangements have been shown and described, the skilled artisan should recognize that templates for substantially anything that may be put in a floral arrangement, including flowers, berries, leaves, twigs, lights, and non-plant ornaments (e.g., plastic or glass ornaments), may be added to these embodiments by a user, such as by uploading digital images thereof into the system.

Accordingly, the specification and drawings are to be regarded in an illustrative rather than a restrictive sense.

Furthermore, embodiments of the present invention include a computer program code-based product, which includes a computer readable storage medium having program code stored therein which can be used to instruct a computer to perform any of the functions, methods and/or modules associated with the present invention. The computer storage medium includes any of, but not limited to, the following: CD-ROM, DVD, magnetic tape, optical disc, phase-change memory, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

It should be further understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. A computer-implemented tool for creating a virtual floral arrangement, comprising:
a floral template module including at least one electronic floral template;
a flower type module including at least one flower type set associated with the floral template, the flower type set including one or more flower types;
a parameter module including a parameter set associated with at least one of the floral template and flower types, the parameter set including at least one randomizable parameter;
a graphical user interface module configured to generate a graphical user interface configured to display the at least one floral template to a user;
the graphical user interface configured to display the at least one flower type set and to permit the user to select from among the one or more flower types for display;
a flower randomizer configured to randomize the randomizable parameter, to generate variations in appearance of the displayed flower type;
wherein a draft arrangement is created and displayed, and which includes the template and the selected flower type, including the randomized parameter.

2. The tool of claim 1, further comprising at least one electronic floral arrangement template set including a plurality of floral templates, wherein the user interface is configured to display and permit the user to select from among the plurality of floral templates.

3. The tool of claim 2, wherein the template set comprises a plurality of predetermined floral templates.

4. The tool of claim 2, further comprising a plurality of electronic floral arrangement template sets, wherein the user interface is configured to display and permit the user to select from among the floral arrangement template sets.

5. The tool set of claim 1, wherein the user interface is configured to display the parameter set and permit the user to select from among the parameters thereof.

6. The tool of claim 1, wherein the parameter set includes parameters selected from the group consisting of flower color, flower size, flower shape, petal color, petal shape, petal size, petal density, arrangement size, arrangement shape, stem length, cost, season of flower, occasions, date, lighting, venue dimensions, table dimensions, suitable combinations of flowers and templates, and combinations thereof.

7. The tool of claim 1, wherein the flower type set includes flower types selected from the group consisting of candles, electric lights, berries, greenery, fruit, non-plant ornaments, plastic ornaments, artificial flowers, and combinations thereof.

8. The tool of claim 1, wherein the template set includes templates selected from the group consisting of wreaths, bouquets, centerpieces and combinations thereof.

9. The tool of claim 1, wherein the template set includes templates selected from the group consisting of a dome, pyramidal, crescent, triangle, fan, oval, horizontal, inverted T, L shape, horizontal, and combinations thereof.

10. The tool of claim 1, wherein the template set includes templates selected from the group consisting of nosegays, beidermeiers, crescents, armsheafs, fans, pomanders, cones, cascades, and combinations thereof.

11. The tool of claim 1, further comprising a container set including at least one container selectable by a user via the user interface for inclusion in the draft arrangement.

12. The tool of claim 11, wherein the container set includes containers selected from the group consisting of vases, baskets, boxes, and combinations thereof.

13. The tool of claim 1, further comprising a placement randomizer configured to distribute a chosen flower type randomly in predetermined locations within the draft arrangement.

14. The tool of claim 13, wherein the placement randomizer is configured to adjust locations of individual flowers in the draft arrangement, by up to about 5 cm in a life-size rendering.

15. The tool of claim 1, wherein the set of parameters includes a set of randomizable parameters selected from the group consisting of petal color, petal shape, petal size, flower shape, flower size, stem length, petal density, and combinations thereof.

16. The tool of claim 1, wherein the set of parameters includes a set of non-randomizable parameters selected from the group consisting of seasons for which a flower type is normally available; templates for which a flower type is suitable; occasions for which a flower type is suitable; date when the floral arrangement would be used, cost of the flower type, and combinations thereof.

17. The tool of claim 1, wherein the user interface is configured to display the draft arrangement in a 360 degree view.

18. The tool of claim 17, wherein the user interface is configured to allow a user to rotate the 360 degree view.

19. The tool of claim 1, wherein the user interface is configured to display a 3 dimensional view.

20. The tool of claim 1, wherein the user interface is configured to allow a user to zoom the display.

21. The tool of claim 1, wherein the template set is configured to be edited by the user.

22. The tool of claim 1, wherein the template set is configured to include floral templates added by the user.

23. The tool of claim 1, wherein the at least one electronic floral template is pre-populated with the one or more flower types, and the user interface is configured to permit the user to edit the template by any one or more of removing a flower type, adding a flower type, selecting a parameter from the parameter set, and deselecting a parameter from the parameter set, and wherein the user interface is configured to display the edited template.

24. The tool of claim 1, being configured for use in a client-server environment, wherein at least one of the floral template module, the flower type module, and the parameter module, is associated with a server computer accessible by a user at a client computer, wherein the graphical user interface module is configured to present the graphical user interface on the client computer.

25. A computer-implemented method for creating a virtual floral arrangement, the method comprising:
(a) providing at least one electronic floral template;
(b) associating at least one flower type set with the floral template, the flower type set including one or more flower types;
(c) associating a parameter set with at least one of the floral template and flower types, the parameter set including at least one randomizable parameter;
(d) enabling a graphical user interface to display the at least one floral template to a user;
(e) permitting the user to select from among one or more flower types for display to the user; and
(f) randomizing the randomizable parameter, to generate variations in appearance of the displayed flower type;
wherein a draft arrangement is created and displayable on the user interface, the draft arrangement including the template and the selected flower type, including the randomized parameter.

26. An article of manufacture for creating a virtual floral arrangement, the article of manufacture comprising:
a computer usable medium having a computer readable instructions embodied therein, the computer readable instructions including instructions for:
(a) providing at least one electronic floral template;
(b) associating at least one flower type set with the floral template, the flower type set including one or more flower types;
(c) associating a parameter set with at least one of the floral template and flower types, the parameter set including at least one randomizable parameter;
(d) enabling a graphical user interface to display the at least one floral template to a user;
(e) permitting the user to select from among one or more flower types for display to the user; and
(f) randomizing the randomizable parameter, to generate variations in appearance of the displayed flower type;
wherein a draft arrangement is created and displayable on the user interface, the draft arrangement including the template and the selected flower type, including the randomized parameter.
